(19) United States
(12) Patent Application Publication
(10) Pub. No.: US 2002/0161771 A1
(43) Pub. Date: Oct. 31, 2002

(54) System for receiving, storing and updating data over a network upon request

(76) Inventor: David M. Boshko, West Palm Beach, FL (US)

Correspondence Address: HOLLAND & BONZAGNI, P.C., Longmeadow Professional Park, Suite 302, 171 Dwight Road, Longmeadow, MA, 01106-1700, US

(21) Appl. No.: 09/828,549

(22) Filed: Apr. 6, 2001

Related U.S. Application Data
(60) Provisional application No. 60/195,677, filed on Apr. 7, 2000.

(51) Int. Cl. G06F 7/00

(52) U.S. Cl. 707/100

(57) ABSTRACT

Member individuals submit contact (or other) information over a network to a server, which stores the information as data records. The members each choose a password and are assigned an identification code (“IDC”), both of which correspond to the members' respective data records. The passwords allow the members to access and modify the information contained in their respective data records, while the IDCs allow recipients, who are given the IDCs, to access (but not to modify) the data records over the network. To do so, the recipient accesses an interface program. The IDCs received by the recipient are entered into the interface program, which downloads from the server copies of the data records corresponding to the IDCs on the list. The interface program can access the server to view and update the local copies of the data records subsequent the members modifying the information stored in their respective data records.

The application is based in part on a Provisional Application, Serial No. 60/195,677, filed Apr. 7, 2000.

### FIELD OF THE INVENTION

The present invention relates to computer-implemented, network-based information systems for storing, distributing, and updating information.

### BACKGROUND OF THE INVENTION

Today, most people have a veritable portfolio of “personal contact information,” e.g., home addresses, business addresses, home phone numbers, cell phone numbers, e-mail addresses, and the like. Typically, this information is easily distributed on a piecemeal basis, or via traditional business cards, to those with whom a person comes into contact. However, if any of this information ever changes, which can happen quite frequently, it is oftentimes desirable and/or necessary to apprise these individuals of the changes. In the case of relatives and close acquaintances, this is laboriously accomplished via phone calls, traditional mail, or e-mail. In the case of many informal business contacts (e.g., people who have received a business card in passing), it is impossible.

Fortunately, though, most people also have access to computer-based networks, such as the Internet, which can be used as means for storing, cataloging, and distributing information for various purposes. Despite this, however, current information distribution systems are fairly limited in scope, generally being merely updated counterparts to print media.

For example, U.S. Pat. No. 5,913,212 to Sutcliffe et al. relates to a “personal journal” system which can be used to record and access various “personals” (personal advertisements). In one embodiment, a server computer maintains a database wherein user individuals pay to record personal messages, which are stored in virtual database “boxes.” Third persons can access the database to view the personal messages and leave responses. The user individuals are given passwords to access their respective boxes, retrieve the responses, and/or modify their personal messages. In another system, as disclosed in U.S. Pat. No. 5,813,006 to Polnerow et al., an on-line directory service includes a server with a database comprising a number of data records (e.g., “white pages” information). Users can access the server over a network (typically the Internet) to view, but not modify, the data records. However, it is possible for a user to register with the server, in which case the user can create new data records or modify the user's existing data records.

As should be appreciated, while these existing information distribution systems are generally useful for their intended purposes, e.g., as “electronic” white pages or personals, they do nothing to alleviate the above-mentioned problem of effectively distributing and updating personal contact or other information.

Accordingly, it is a primary object of the present invention to provide a network-based system for distributing and updating personal contact (or other) information.

Another object of the present invention is to provide a system for allowing “member” individuals to maintain and modify data records, containing personal contact (or other) information, on a network-accessible server.

Another object of the present invention is to provide a system wherein recipient individuals can access, but not modify, the data records over the network via a code given to them for such a purpose by the member individuals.

Yet another object of the present invention is to provide a system wherein data records received by the recipients are updated when changes are made to corresponding records on the server by the member individuals.

### SUMMARY OF THE INVENTION

According to the present invention, member individuals submit biographical or general contact information (e.g., name, address, phone number, e-mail address) over a network to a server terminal (a computer or other electronics device), which stores the information in database data records. The members each receive a unique password and a unique IDentification Code (“IDC”), both of which correspond to the members' respective data records. The passwords allow the members to access and modify the information contained in their respective data records, while the IDCs allow third persons to access (but not to modify) the data records over the network. The IDCs may be typed on business cards or otherwise disseminated by the members to third persons (“recipients”), who may be friends, relatives, business contacts, or the like.

For a recipient to access the data records (after receiving one or more IDCs from member individuals), an interface software program is accessed. The interface program runs locally on the recipient's terminal. To use the program, the recipient enters all the IDCs given to him or her by member individuals. The interface program keeps a list of the IDCs, accesses the server over the network, and downloads copies of the data records corresponding to the IDCs on the list. Further information, such as advertising banners, can also be downloaded and automatically updated for display on the recipient's terminal. The data record copies are stored on the recipient's terminal, allowing the recipient to view the data records upon command and without having to access the network. Also, the interface program can access the server on command to update the local copies of the data records subsequent the members modifying the information stored in their respective data records on the server.

For expediting the updating process, the data records are each assigned a “revision level” number or time stamp notifier. Each time a data record is downloaded to a recipient's terminal, its revision level number is included. Also, each time a member individual modifies his or her data record on the server, the record's revision level number is incremented. When the interface software accesses the server, it compares the revision numbers of the IDCs on its list to the revision numbers of the corresponding data records on the server. If any of the revision numbers have been incremented, the interface software knows that the corresponding data records have been modified, downloads copies of them, and notifies the recipient of the modifications.

As should be appreciated, a member can give his or her IDC to many recipients, which allows them to download and subsequently view the member's contact information. Each time the member moves, changes phone numbers, or otherwise, he or she no longer has to contact each recipient individually. Instead, the member makes the particular changes to his or her data record on the server, and the corresponding data records stored on the recipients' terminals are automatically updated when the interface software programs access the server.

### BRIEF DESCRIPTION OF THE DRAWINGS

These and other features, aspects, and advantages of the present invention will become better understood with respect to the following description, appended claims, and accompanying drawings, in which:

FIG. 1 is a schematic view of various computer systems interconnected across a network and implementing the information distribution and updating system of the present invention;

FIG. 2 is a flow chart of a routine executing within a server terminal, by which a member individual can establish or modify a data record within a database controlled by the server;

FIG. 3 is a flowchart showing the steps taken by a recipient terminal to download an interface program for retrieving and updating data records from the server database; and

FIG. 4, consisting of FIGS. 4A and 4B, is a flow chart showing the operation of the interface program in the recipient terminal.

### DETAILED DESCRIPTION OF THE PREFERRED EMBODIMENT

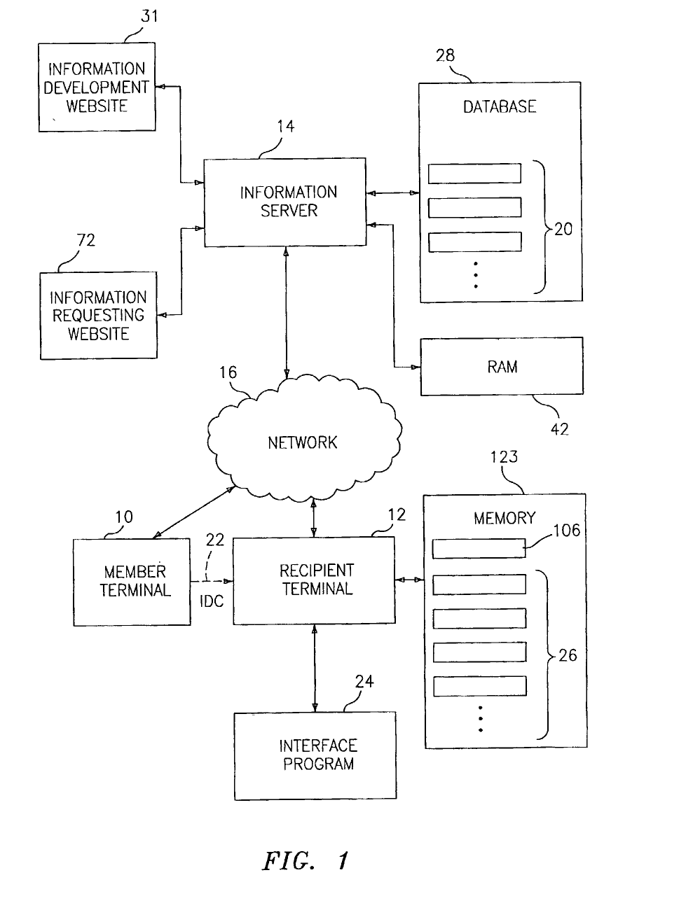

Turning now to FIGS. 1-4, a preferred embodiment of a system for receiving, storing, and updating data over a network upon request, according to the present invention, will now be given. The information distribution and updating system comprises a member terminal 10, a recipient terminal 12, and an information server 14, all interconnectable through a network 16. A “member” individual accesses the server 14 (via the terminal 10) to set up an account, by which the member creates a data structure (record) 20, containing contact information (name, address, phone number) or other information to be disseminated. The member selects a password and is assigned a specific IDentification Code (“IDC”) 22, both of which correspond to the member's data record 20. The password authorizes the member to modify his or her data record 20, while the IDC 22 is given out to various “recipient” individuals (friends, acquaintances, or anyone else with whom the member would like to share the information contained in his or her data record 20). To retrieve the information in the data record 20, each recipient accesses the server 14 via an interface program 24, which runs on the recipient's terminal 12. The IDC 22 (and any other IDCs which the recipient has received) is entered into the interface program 24, which accesses the server 14, and downloads and stores a displayable copy 26 of the data record 20. The interface program 24 also allows access to the server 14 to update the local copy 26 of the data record 20, if necessary. In this manner, the member no longer has to contact each recipient when the information contained in his or her data record 20 is modified; rather, the changes are automatically disseminated when the interface programs 24 update the local data record copies 26.

FIG. 1 is a schematic view of a plurality of computing systems interconnected through the network 16 in order to practice the present invention. The network 16 can be of any type, such as a switched telephone network system like the Internet, a wireless network, or a local area network. The computing systems include the member terminal 10 (a computer or other electronic device, such as a PDA or cell phone), which is operated by or on behalf of a business professional or other individual or organization (the members) desiring to make certain types of business (or other) information readily available to a number of acquaintances, associates, or others (the recipients). The recipient terminal 12 (again, a computer or other electronic device) is operated by or on behalf of one of such recipients. The information server 14 is operated by or on behalf of a business entity providing a service to make information accessible through the member terminals 10 available to the various recipient terminals 12.

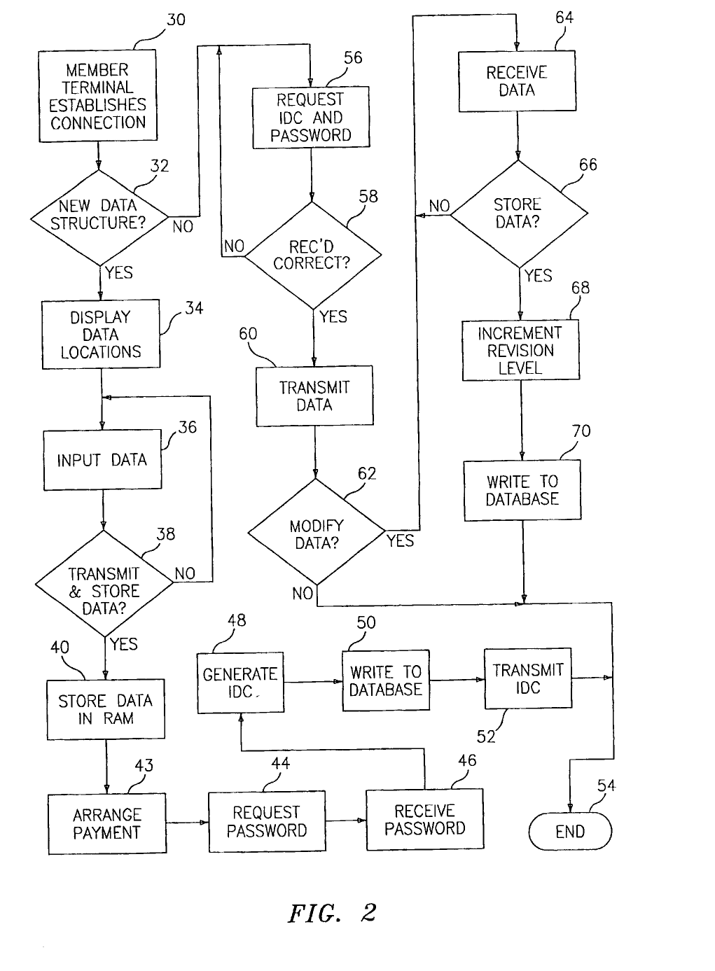

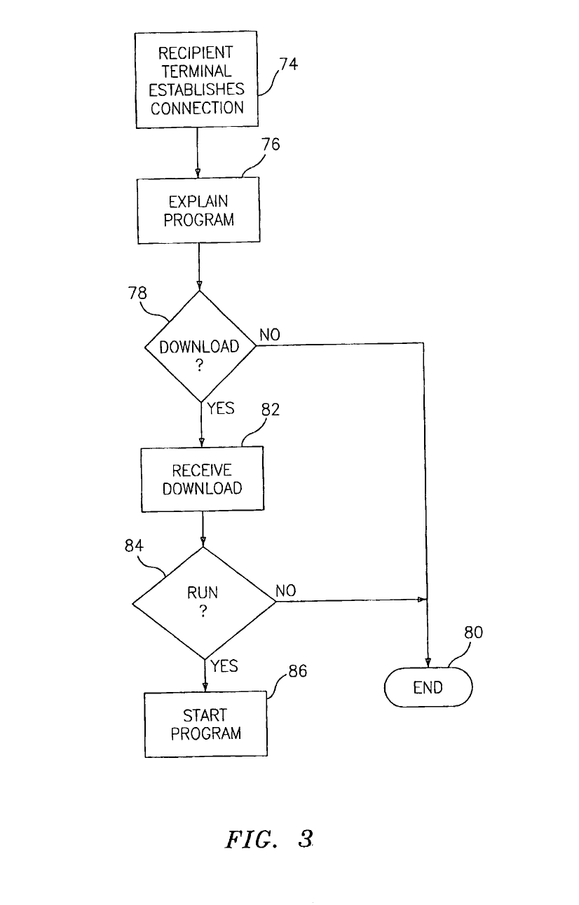

FIG. 2 is a flow chart of a routine executing within the information server 14 to establish or modify a data structure (e.g., record or file) 20 within a database 28 controlled by the information server 14. The establishment of such a data record begins the process of information transfer in accordance with the present invention. This data record 20 is established in response to a connection made over the network 16 by means of the member terminal 10 in step 30. This connection is preferably made through the use of a specific URL (Uniform Resource Locator), which accesses an information development web site 31 through the information server 14. The person contacting this web site (the member) is first asked if he or she wants to either establish a new data record or to modify an existing data record. If a determination is made in step 32 that an existing data structure is to be modified, the system proceeds to a subroutine which will be discussed in further reference to FIG. 2.

On the other hand, if a determination is made in step 32 that a new data structure is to be established, in step 34, the information development web site 31 causes a number of predetermined data entry locations or fields to be displayed on the screen of the member terminal 10, e.g., via the information development web site 31 interacting with a conventional browser or other program on the member terminal 10. Such fields can include requests for contact information (name, address, phone number, e-mail address, etc.) or other types of information. Next, in step 36, the member fills in data at the various predetermined data entry locations. The information development web site 31 also includes locations which may be selected, using the browser or other similar program, to provide control functions, such as submitting and storing the data displayed on the screen. When this transmission and/or storage control function is selected, as determined in step 38, the information written at the predetermined data locations is transmitted over the network 16 to the information server 14, which, in step 40, causes the information to be written into temporary storage 42.

In accordance with the present invention, payment may be required to be made through the member terminal 10 for the various services provided through the use of the information server 14. Secure methods for making such payments are well known to those skilled in the art of arranging for financial transactions over the Internet or other network. For example, the type of routine used by ISPs (Internet Service Providers) to arrange for payments may be used. Such a routine typically provides for a number of options, such as charging to a credit card or bank account, with predetermined monthly chargers being automatically made. Since this type of routine is well known, it is simply referred to as a payment arranging routine 43. This routine 43 includes a number of subroutines interacting with other terminals (not shown) to establish, for example, whether a credit card number is valid.

Upon the successful completion of the payment arranging routine 43, if such is required, the information server 14, in step 44, requests the person operating the member terminal 10 to supply a password, which will be subsequently required before the data record corresponding to the IDC 22 can be modified. Optionally, the password may be established before payment is arranged. After the password is received in step 46, the information server 14, in step 48, assigns the IDC 22, which is subsequently used to access the information in the particular data structure 20 corresponding to the IDC. In general, the database 28 stores a large number of data structures 20, each of which corresponds to a particular IDC. Then, in step 50, the data stored in temporary storage in step 40 is written to the database 28 at a location which may later be accessed using the IDC. Next, in step 52, the IDC is transmitted from the information server 14 to the member terminal 10. Then, the routine is finished in step 54.

The preceding discussion has described operations occurring when a person operating the member terminal 10 initiates a request to establish a new IDC 22 and a new data record 20. A request may also be initiated to modify an established data record 20 having an established IDC. A determination is made that an incoming request relates to an established data record instead of a new data record in step 32. Then, in step 56, the subroutine asks for the IDC 22 of the existing data record 20 to be modified and for the associated password, in order to prevent an unauthorized person from modifying the data record 20 stored in the database 28. After it is determined in step 58 that this information has been properly received, the information in the data record 20 associated with the IDC 22 is transferred, in step 60, to fill data locations displayed on the member terminal 10. In step 62, the person operating the member terminal 10 then modifies the material, if desired, by selecting the data entries he or she wishes to change and by entering the data over these entries, in a conventional manner, with the system receiving the data in step 64. Once finished, this fact is indicated, causing a determination to be made in step 66. The data structure 20 stored in the database 28 includes a revision level which is incremented in step 68 each time a portion of this data is revised. This revision level is subsequently used to determine if information stored by a recipient terminal 12 is at the latest level (i.e., current). Next, in step 70 the modified data is written to the database 28. When this process is completed, the subroutine ends in step 54.

After completing the processes described above in reference to FIG. 2, the member to whom or for whom the member terminal 10 is operated distributes his or her IDC 22 to various recipients that are to have access to the information stored on the member's behalf, located within the database 28. The member may use any number of methods to distribute his or her IDC, including, but not limited to, verbal conveyance, printing, or attaching or incorporating the IDC on business cards.

FIG. 3 is a flowchart showing steps of a routine executing within the recipient terminal 12, as this terminal 12 is used to contact an information requesting web site 72 accessed through the information server 14 in order to receive the downloaded interface program 24 for working with data accessible through the use of IDCs. This web site 72 is preferably reserved for this type of call, having been accessed by means of a specific URL, which may have been provided to the recipient operating the recipient terminal 12 along with an IDC, or which may have been learned by the recipient through another means, such as advertising (alternatively, it should also be noted that the functions of the information requesting web site 72 and the information developing web site 31 could be provided together on one web site).

This routine begins in step 74, with the recipient terminal 12 establishing a connection with the information requesting web site 72. Next, in step 76, the recipient terminal 12 displays information from the web site 72 explaining the interface program 24 to be downloaded. Then, in step 78, the recipient indicates whether he or she wishes to download the program. If the recipient does not, the process ends in step 80, with the recipient terminal 12 disconnecting from the information requesting web site 72. Otherwise, the interface program 24 is received in step 82. Preferably, the interface program 24 is provided free of cost to the recipient. One or more advertising messages, or banners, may be downloaded along with the program 24, for subsequent display at the recipient terminal 10 during operation of the interface program 24. Next, in step 84, the recipient is asked if he or she wishes to run the program 24. The recipient may want to run the program 24 at this point to search for information related to specific IDCs, or the recipient may want to merely load the program 24 so that it will be available for later use. If the recipient does not want to run the program 24, the process ends in step 80, with the recipient terminal 12 disconnecting from the information requesting web site 72. Otherwise, the interface program 24 is started in step 86.

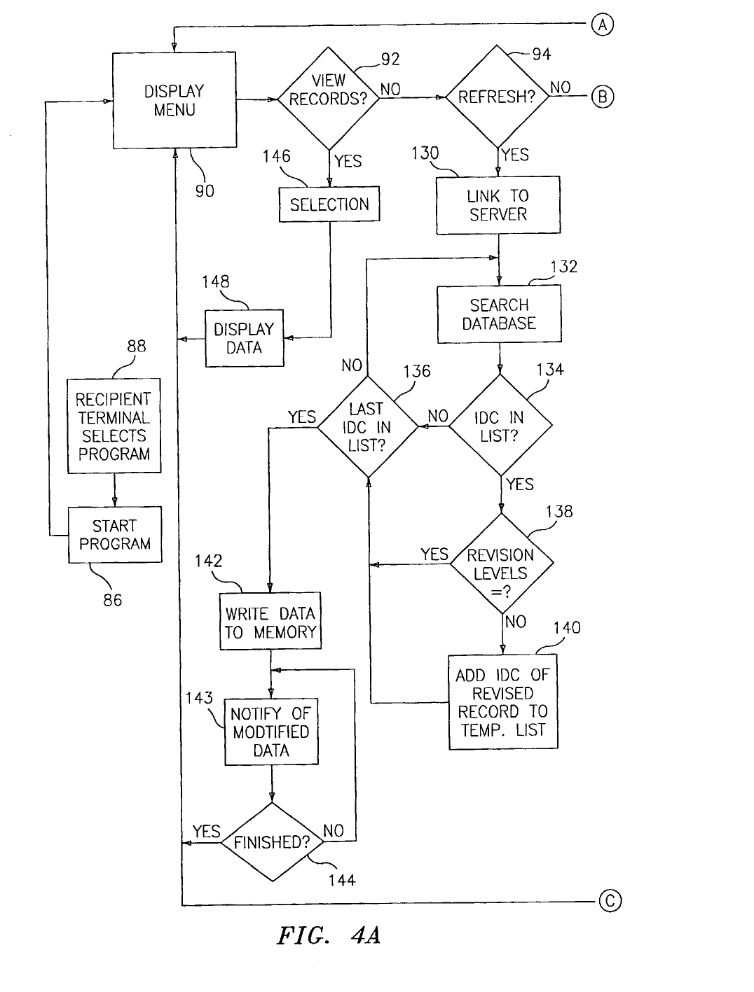

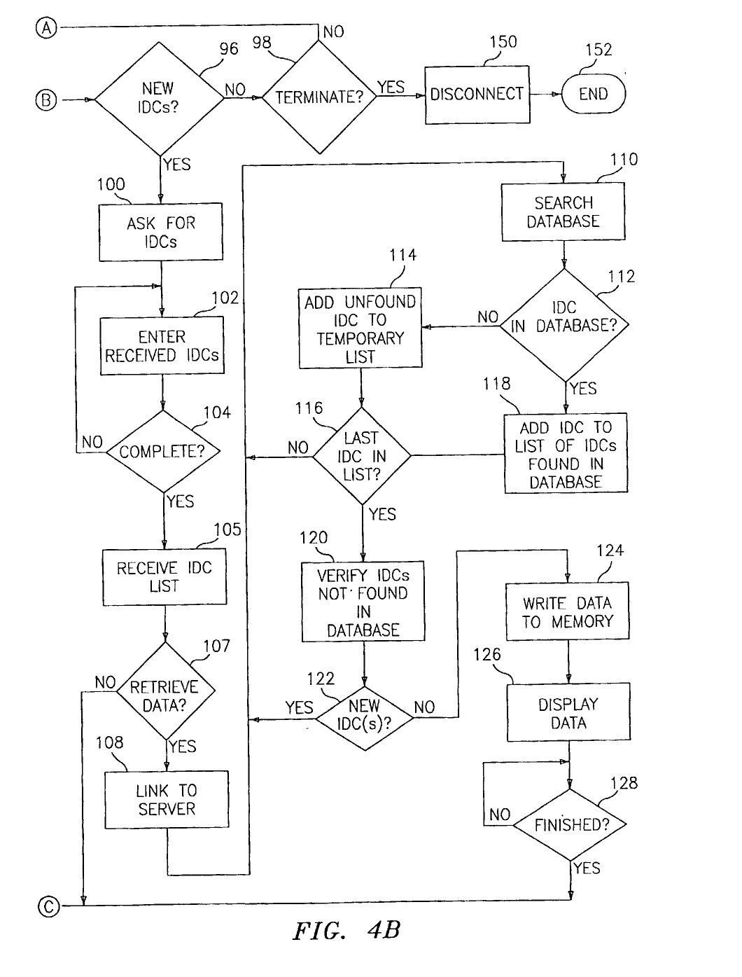

FIG. 4, which consists of a first part FIG. 4A and a second part FIG. 4B, is a flow chart showing operation of the interface program 24 in the recipient terminal 12 when the recipient uses the interface program 24 to find stored data, having chosen to run the program 24 in step 84 (FIG. 3) subsequent downloading, or having selected the program at some later point in time in step 88.

From this point at step 86, the program 24 executes within the recipient terminal 12. The interface program 24 displays a menu at step 90 by which the recipient can choose to review existing local data records 26 at step 92, refresh (update) existing local data records 26 at step 94, add new IDCs 22 (and download copies of the data records 20 corresponding to the new IDCs) at step 96, or terminate the program 24 at step 98. Other functions, such as a calendar and the ability to import/export data to other programs may also be included on the menu.

If it is determined that new IDCs are to be entered at step 96 (as would typically be the case for a recipient using the interface program 24 for the first time), the program 24 asks for a list of IDCs at step 100. Then, in step 102, a list of IDCs received from member individuals, are provided by the recipient as a keyboard input. When the list is complete, the recipient selects a control button on the display screen indicating this fact, and causing a determination to be made in step 104. Next, the list of IDCs is received by the interface program at step 105 and stored as a master list of IDCs 106 (e.g., a cumulative list of all IDCs entered by the recipient individual). Then, in block 107, the recipient is asked if he or she wants to retrieve the data now. If the recipient indicates “no,” the interface program 24 returns to the menu at step 90. If the recipient indicates “yes,” the interface program 24 establishes a link between the recipient terminal 12 and the information server 14 at step 108, if necessary (typically, the interface program 24 will establish a link the first time it is required and then terminate the link once the interface program itself is terminated; optionally, the link can be created and terminated whenever necessary).

At this point, the program executing in the recipient terminal 12 is allowed to search the database 28 and to retrieve data from it. Thus, in step 110, the interface program 24 searches the database 28 for the first IDC from the list of IDCs received in step 102. If it does not match any of the IDCs in the database 28, as determined at step 112, a notation is made at step 114 that that IDC was not found in the database 28, and a determination is made in step 116 of whether the end of the recipient terminal list 106 has been reached. If it has not, the search is repeated in step 110 for the next IDC from the list 106. On the other hand, if it is determined at step 112 that the IDC being evaluated matches one of the IDCs in the database 28, the server adds that IDC to a temporary list of IDCs found in the database 28 at step 118, and then checks to see if the end of the list 106 has been reached. If not, the search is repeated at step 110 for the next IDC from the list 106.

If the database 28 has been searched for all the IDCs on the recipient terminal list 106, the recipient is asked, in step 120, to verify the IDC(s) from the list not found in the database 28, if any. If he or she submits one or more new IDCs, as determined in step 122, the interface program 24 returns to step 110 to begin searching for the new IDCs. Otherwise, the data records 20 associated with the IDCs found to be in the database 28, as noted in step 118, are copied to a memory 123 of the recipient terminal 12 in step 124 (as the local copies 26 of the data records 20), and this data is displayed on the screen of the recipient terminal in step 126, identifying some portion of the information (contact, etc.) associated with each of the IDCs in the list in step 102. When the recipient indicates that he or she is finished reading the displayed information, as determined in step 128, the interface program returns to await another menu command at step 90. Optionally, the data can remain displayed on the screen.

As should be appreciated, the memory 123 of the recipient terminal 12 can be a hard drive, flash memory, temporary memory, recordable optical media, floppy disks, or any other type of memory or recordable storage media.

From the menu displayed at step 90, the recipient may select to refresh at step 94. The interface program 24 has an ability to access both the local copies 26 of the data records 20 in the memory 123 and the files 20 of the information server 14 in the database 28. The files 26 in the memory 123 can be accessed most quickly, but they may contain outdated information, since the member terminals 10 update only the files within the database 28. If the option to refresh is exercised, the downloaded interface program 24 will connect with the information server 14 to determine if the files 20 within the database 28 corresponding to the files 26 within the memory 123 have been modified, since the information was last transferred from the database 28 to the memory 123.

Thus, if a decision to refresh has been made, as determined in step 94, the interface program 24 links the recipient terminal 12 to the information server 14 through the network 16, at step 130, if necessary. At this point, the interface program 24 executing in the recipient terminal 12 is allowed to search the database 28 and to retrieve data from it. Thus, in step 132. the program searches the database 28 for the IDCs on the master list 106 maintained by the interface program 24. In step 134, if an IDC stored in the recipient terminal does not match any of the IDCs in the server database 28, the interface program 24, at step 136, checks to see if the IDC that has just been evaluated is the last IDC in the list 106. If not, the search is repeated in step 132 for the next IDC on the list 106.

On the other hand, if the IDC being evaluated matches one of the IDCs in the database 28, a determination is made at step 138 of whether the revision level associated with the IDC and stored within the memory 123 matches the corresponding revision level stored in the database 28. If these revision levels match, the level of information stored in the memory 123 is the same as that stored in the database 28, so the system returns to step 136 to see if the IDC that has just been evaluated is the last IDC on the list 106. If not, the search is repeated in step 132 for the next IDC.

If the revision levels do not match, as determined at step 138, the data record 20 corresponding to this particular IDC has been modified since the last time it was transferred to the memory 123. At step 140, a notation is made of the IDC corresponding to the revised record 20, and the system returns to step 136 to see if the IDC that has just been evaluated is the last IDC on the list 106 stored on the recipient terminal. If not, the search at step 132 is repeated.

Once all the IDCs on the list 106 are evaluated, i.e., the system determines at step 136 that the IDC that was just evaluated is the last IDC on the list 106, the refresh process is applied to the data records 20, 26 associated with IDCs noted at step 140, if any, with data being written from the database 28 to the memory 123 of the recipient terminal 12 in step 142, overwriting data previously stored in the memory 123. Then, the program notifies the recipient of all the data which has been modified during this process, by means of a list of data presented on the display screen in step 143. When the recipient is finished reviewing this displayed data, he makes a selection on the screen indicating that he is finished, causing a determination to be made in step 144. After this, the program 24 proceeds back to the menu at step 90 to await a further command. Alternatively, the modified data can remain on the screen, along with the displayed menu.

From the menu, the recipient may select at step 92 to display the various local copies 26 of the data records 20, which are stored on the memory 123. First, the interface program 24 displays various index entries of data stored in the memory 123. While each of these index entries is used as a key for retrieving information related to an IDC, these entries preferably include easily remembered classifications, such as the name of an individual or of a company, along with the associated IDC. Next, in step 146, the recipient selects as many of these entries as he or she desires, with the data corresponding to each of the entries being displayed in step 148. Of course, the interface program can include further database functions for searching, sorting, printing, etc., the data records 26.

As should be appreciated, the record display function may take place in parallel with the other options available via the menu on the interface program 24. That is, in addition to showing the menu, the interface program may automatically display the listing of index entries, along with the partial or full contents of the data records 26 associated with the index entries.

Finally, from the menu, the recipient is able to terminate the interface program at step 98, in which case the program disconnects from the server at step 150 and ends at step 152.

In accordance with a preferred version of the present invention, other messages, such as advertisements, are also modified with the refresh process in the above-described manner, so that the level of advertising material within the memory 123 matches the level of such material stored in the database 123.

Thus, information recorded on a real-time basis is made available to the recipient on an on-demand basis. The information stored in the memory 123 is written in a machine-readable format.

While the preceding discussion describes the use of IDCs to find data structures, various fields within the data structures may be searchable. During the process of searching data held within the memory 123, and also during the process of searching data held within the database 28, key words or categories representing areas of business for which one wishes to find information can be provided as inputs.

Where it has been noted herein that the recipients are able to access the records, but not to modify them, it should be appreciated that this means that the recipients should not be allowed to modify the records 20 in the server database 28. However, optionally, the recipients may be allowed to modify the local data record copies 28 stored on the recipient terminals. This would allow the recipients to add further information to the data record, including further contact information, comments, or the like. Additionally, it may be possible for the recipients to enter entirely new data records into their local databases. These could not necessarily be refreshed (since there would likely not be a corresponding data record on the server), but it would enable the local database to be used as a general information storage/organization/retrieval means.

Although the present invention has been described with reference to “members” and “recipients,” it should be appreciated that in many (if not most) situations a member will also be a recipient, i.e., a person establishing a data record 20 within the database 28 controlled by the information server 14 will also likely have access to the interface program 24 so that he or she can receive information relating to others' IDCs. Additionally, while most of the description set forth above was given in terms of a single member and/or member terminal and a single recipient and/or recipient terminal, it should be remembered that in almost any practical implementation of the present invention there will be numerous members and recipients.

Also, although the system for receiving, storing, and updating data over a network upon request of the present invention has been illustrated as having a member establish an account (password, payment, data record, etc.) by accessing the information development web site 31 through the information server 14, e.g., via a browser over the Internet, one of ordinary skill in the art will appreciate that the interface program 24 could be used as a means of establishing an account and/or modifying an existing data record 20, without departing from the spirit and scope of the invention. In this case, the interface program would be initially downloaded, and would have menu options for establishing an account and modifying an account, by either accessing a web site or by direct communication to the server (e.g., the interface program would include data entry/modification screens).

Additionally, although it has been shown that the member individuals establish accounts (and data structures) by accessing the server computer, it should be appreciated that the accounts could be established in other ways. For example, the accounts could be automatically established when the member individuals set up an account for accessing a network, e.g., when the member individuals set up an account with an ISP or a cellphone or wireless network provider. In such a case, the member individuals would be asked to supply a password, and a portion of the personal information used by the member individuals to set up the accounts would be used to create a data structure on the server terminal, with the entity facilitating the account creation informing the member individuals of the identification codes associated with their respective data structures.

For example, in the case of a member individual establishing a cellphone account, the customer service associate establishing the account for the member individual would explain the information dissemination system, and ask the member individual if he or she would like to participate (of course, participation could be mandatory). Then, the customer service associate would input the member individual's billing and other information into a terminal used to create cellphone accounts, but that also had access to the server terminal. Some of the information used to create the cellphone account would be provided to the server terminal to create a data structure for the member individual, and the server terminal would communicate the identification code associated with the data structure to the terminal used by the customer service associate, who would then communicate the identification code to the member individual, along with other relevant information (e.g., how to access the server terminal by way of the member individual's cellphone or otherwise). Of course, the member individual could later modify his or her data structure so that it only contained the information the member individual desired to disseminate.

Furthermore, although the present invention has been illustrated as having recipient individuals download and/or access the interface program, one of ordinary skill in the art will appreciate that the interface program could be initially included as part of the software included with an electronic device upon purchase. For example, in the case of a wireless PDA (Personal Digital Assistant), the interface program could be included as part of the PDA's firmware, platform, or operating system.

Where certain portions of the system of the present invention have been called “networks,” it should be appreciated that by this term it is meant any device or grouping of devices remotely (or otherwise) accessible by another device for information exchange, which includes what is commonly known as the Internet. Also, the term “web site” is meant in a broad sense to include what are commonly known as web sites (virtual places on the Internet whose function is to provide information on various topics, products or services), as well as any programs or computer or electronic device interfaces for facilitating communications and/or data entry between devices on a network and/or users.

As should be appreciated, the server terminal of the present invention can be accessible by way of more than one network, e.g., via a wireless network and the Internet. Accordingly, the server terminal could be provided with means for accessing various networks and/or could be configured to maintain a number of different access points, such as websites for Internet access and direct interfaces for interacting with wireless devices.

Although the IDCs of the present invention have been illustrated as being assigned by the server, one of ordinary skill in the art will appreciate that the system of the present invention could allow the member individuals to select their own IDCs (e.g., if another member has not already chosen the IDC), or require the members to utilize an existing identifier as the IDC. However, it should be appreciated that in some circumstances it will be advantageous to have the IDCs be in a particular format adapted for ease of entry into the particular recipient terminal (e.g., in the case of cellphones, numeric or alphanumeric IDCs are adapted for ease of entry).

Since certain changes may be made in the above described system for receiving, storing, and updating data over a network upon request, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Having thus described the invention, what is claimed is:

1. An electronic data storage and distribution system comprising:
a. a server terminal maintaining a master data structure having a password and a unique identification code associated therewith, said data structure including information for dissemination provided by a member individual with access to the server terminal, wherein the master data structure can be modified by the member individual providing to the server terminal the password and unique identification code associated with the master data structure; and
b. an interface program running on a recipient terminal operated by a recipient individual and connectable to the server terminal, wherein the interface program is configured to:
(i) receive the identification code as input from the recipient individual, said identification code having been disseminated from the member individual to the recipient individual;
(ii) obtain from the server terminal a copy of the master data structure associated with the identification code and to store said copy as a local data structure; and
(iii) to access the server terminal to determine if the master data structure associated with the inputted identification code supplants its corresponding local data structure, by virtue of having been modified, and, if so, to replace the supplanted local data structure with a copy of its corresponding, modified master data structure from the server terminal.

2. The electronic data storage and distribution system of claim 1 wherein the interface program is obtained by the recipient terminal from the server terminal.

3. The electronic data storage and distribution system of claim 1 wherein the interface program is provided on the recipient terminal as part of a group of bundled software included with the recipient terminal upon purchase.

4. The electronic data storage and distribution system of claim 1 wherein the interface program is further configured to automatically periodically access the server terminal to determine if the master data structure associated with the inputted identification code supplants its corresponding local data structure.

5. The electronic data storage and distribution system of claim 1 wherein the interface program accesses the server terminal to determine if the master data structure associated with the inputted identification code supplants its corresponding local data structure, upon command of the recipient individual.

6. The electronic data storage and distribution system of claim 1 wherein the interface program is further configured to:
a. display an advertisement; and
b. obtain a new advertisement for display from the server terminal when the server terminal is accessed to determine if the master data structure associated with the inputted identification code supplants its corresponding local data structure.

7. The electronic data storage and distribution system of claim 1 wherein:
a. the server terminal maintains a master advertisement modifiable by authorized individuals; and
b. the interface program is further configured to:
(i) display a locally-stored advertisement; and
(ii) determine if the master advertisement supplants the locally-stored advertisement, and, if so, to replace the locally-stored advertisement with a copy of the master advertisement.

8. The electronic data storage and distribution system of claim 7 wherein the interface program determines if the master advertisement supplants the locally-stored advertisement when the server terminal is accessed to determine if the master data structure associated with the inputted identification code supplants its corresponding local data structure.

9. The electronic data storage and distribution system of claim 1 wherein the unique identification code is assigned by the server terminal.

10. The electronic data storage and distribution system of claim 1 wherein the unique identification code is adapted for ease of entry into the recipient terminal.

11. An electronic data storage and distribution system comprising:
a. a server terminal maintaining a plurality of master data structures each having a password and a unique identification code associated therewith, wherein:
(i) said master data structures contain information provided by member individuals with access to the server terminal; and
(ii) the master data structures can be modified by the member individuals providing to the server terminal the passwords and unique identification codes respectively associated with the master data structures; and
b. an interface program running on a recipient terminal operated by a recipient individual and connectable to the server terminal, wherein the interface program is configured to:
(i) accept identification codes given from the member individuals to the recipient individual, and to obtain copies of the master data structures associated with the accepted identification codes and to store said copies as local data structures; and
(ii) to access the server terminal to determine if any of the master data structures associated with the accepted identification codes supplant their corresponding local data structures, by virtue of having been modified, and, if so, to replace the supplanted local data structures with copies of their corresponding master data structures from the server terminal.

12. The electronic data storage and distribution system of claim 11 wherein the interface program is further configured to automatically periodically access the server terminal to determine if the any of the master data structures associated with the accepted identification codes supplant their corresponding local data structures.

13. The electronic data storage and distribution system of claim 11 wherein the interface program accesses the server terminal to determine if the any of the master data structures associated with the accepted identification codes supplant their corresponding local data structures, upon command of the recipient individual.

14. The electronic data storage and distribution system of claim 11 wherein the member individuals have access to the server terminal via a website.

15. An electronic data storage and distribution system comprising:
a. a server terminal maintaining a plurality of master data structures each having a password and a unique identification code associated therewith, wherein:
(i) said master data structures contain information provided by member individuals having accessed the server terminal via a website maintained by the server terminal for purposes of creating said data structures; and
(ii) the master data structures can be modified by the member individuals accessing the website and providing to the server terminal the passwords and unique identification codes respectively associated with the master data structures; and
b. an interface program running on a recipient terminal operated by a recipient individual and connectable to the server terminal, wherein the interface program is configured to:
(i) accept as input identification codes given from the member individuals to the recipient individual, and to obtain copies of the master data structures associated with the accepted identification codes and to store said copies as local data structures;
(ii) to display the information in said local data structures; and
(iii) to refresh the local data structures upon command by accessing the server terminal to determine if any of the master data structures associated with the accepted identification codes supplant their corresponding local data structures, by virtue of having been modified, and, if so, to replace the supplanted local data structures with copies of their corresponding master data structures from the server terminal.

16. An electronic data storage and distribution system comprising:
a. a server terminal maintaining a data structure having a password and a unique identification code associated therewith, wherein:
(i) said data structure contains information provided by a member individual with access to the server terminal; and
(ii) the server terminal is configured to enable said member individual to modify the data structure upon providing to the server terminal the password and unique identification code associated with the data structure; and
b. an interface program running on a recipient terminal operated by a recipient individual and connectable to the server terminal, wherein the interface program is configured to:
(i) accept the identification code, disseminated from the member individual to the recipient individual, and to obtain from the server terminal a copy of the data structure associated with said identification code; and
(ii) access the server terminal to determine if the data structure on the server terminal has been modified since a copy of the data structure was last obtained, and, if so, to obtain from the server terminal another copy of the data structure to replace the copy that was last obtained.

17. A system for storing and distributing data comprising a server terminal and a plurality of remote terminals connectable to the server terminal, wherein:
a. the server terminal maintains a plurality of master data structures each having a password and a unique identification code associated therewith, said master data structures having been created by individuals accessing the server terminal via the remote terminals, and said master data structures containing information for dissemination provided by the individuals who accessed the server terminal to create the master data structures;
b. the master data structures can be modified by accessing the server terminal via the remote terminals and providing the passwords and unique identification codes associated with the master data structures to be modified; and
c. an interface program runs on at least one of the remote terminals, wherein the interface program is configured to:
(i) receive as input at least one of the identification codes, and to obtain from the server terminal copies of the master data structures associated with the inputted identification codes and to store said copies as local data structures; and
(ii) access the server terminal to determine if any of the master data structures associated with the inputted identification codes supplant their corresponding local data structures, by virtue of having been modified, and, if so, to replace the supplanted local data structures with copies of their corresponding master data structures from the server terminal.

18. A system for storing and distributing data comprising a server terminal and a plurality of remote terminals connectable to the server terminal over a network, wherein:
a. the server terminal maintains a plurality of master data structures each having a password and a unique identification code associated therewith;
b. the master data structures can be modified by accessing the server terminal via the remote terminals and providing the passwords and unique identification codes associated with the master data structures to be modified; and
c. an interface program runs on the remote terminals, wherein the interface program is configured to:
(i) receive as input the identification codes, and to obtain from the server terminal copies of the master data structures associated with the inputted identification codes and to store said copies as local data structures; and
(ii) access the server terminal to determine if any of the master data structures associated with the inputted identification codes supplant their corresponding local data structures, by virtue of having been modified, and, if so, to replace the supplanted local data structures with copies of their corresponding master data structures from the server terminal.

19. The system of claim 18 wherein the master data structures are created by individuals accessing the server terminal via the remote terminals, and said master data structures contain information for dissemination provided by the individuals who accessed the server terminal to create the master data structures.

20. The system of claim 19 wherein the network is the Internet, and the individuals access the server terminal via the remote terminals by way of a website maintained by the server terminal.

21. The system of claim 18 wherein the network is the Internet, and the master data structures are modified by the remote terminals accessing the server terminal by way of a website maintained by the server terminal.

22. The system of claim 18 wherein the master data structures are automatically created by the server terminal upon individuals operating the remote terminals establishing accounts for accessing the network.

23. The system of claim 18 wherein the plurality of remote terminals are connectable to the server terminal over a wireless network.

24. The system of claim 23 wherein the master data structures are automatically created by the server terminal upon individuals operating the remote terminals establishing accounts for accessing the wireless network.

25. The system of claim 23 wherein the remote terminals comprise cellphones, wireless personal digital assistants, and/or wireless computers.

26. The system of claim 18 wherein the interface program is retrieved from the server terminal by the remote terminals.

27. The system of claim 18 wherein the interface program is provided on the remote terminals as part of a group of bundled software upon purchase.

28. An electronic data storage and distribution system comprising:
a. a server terminal maintaining a plurality of data structures each having a password and a unique identification code associated therewith; and
b. an interface program running on a recipient terminal connectable to the server terminal, wherein the interface program is configured to:
c. receive as input one or more of the identification codes and to obtain from the server terminal copies of the data structures associated with the inputted identification codes; and
d. to access the server terminal to update any data structure copies whose corresponding data structures on the server terminal are later modified.

29. The electronic data storage and distribution system of claim 28 wherein the unique identification code is assigned by the server terminal.

30. The electronic data storage and distribution system of claim 28 wherein the unique identification code is adapted for ease of entry into the recipient terminal.

31. The electronic data storage and distribution system of claim 28 wherein the interface program is obtained by the recipient terminal from the server terminal.

32. The electronic data storage and distribution system of claim 28 wherein:
a. an advertisement is obtained by the interface program from the server terminal along with the copies of the data structures associated with the inputted identification codes; and
b. the interface program is further configured to:
(i) display the advertisement on the recipient terminal; and
(ii) receive an additional or alternative advertisement for display from the server terminal when the interface program accesses the server terminal to update any data structure copies whose corresponding data structures on the server terminal are later modified.

33. The electronic data storage and distribution system of claim 28 wherein:
a. the system further comprises a member terminal connectable to the server terminal; and
b. the server terminal is configured to:
(i) receive information to be disseminated from the member terminal;
(ii) create a new data structure to be maintained along with the plurality of data structures on the server terminal, said new data structure incorporating the information received from the member terminal;
(iii) generate and transmit to the member terminal a unique identification code associated with the new data structure; and
(iv) upon receipt from the member terminal of the unique identification code associated with the new data structure and a password associated with the new data structure, to receive further information for modifying the new data structure.

34. The electronic data storage and distribution system of claim 33 wherein the password associated with the new data structure is received from the member terminal.

35. The electronic data storage and distribution system of claim 33 wherein the server terminal is further configured to process an electronic payment transaction associated with the creation of the new data structure.

36. The electronic data storage and distribution system of claim 28 wherein the server terminal is configured to:
a. connect to a member terminal operated by a member individual desiring to create a new data structure on the server computer to be maintained along with the plurality of data structures on the server terminal;
b. receive information from the member terminal to be included in the new data structure;
c. create the new data structure and generate and transmit to the member terminal a unique identification code associated with the new data structure, wherein the member individual can disseminate the identification code associated with the new data structure to a recipient individual operating the recipient terminal; and
d. upon receipt from the member terminal of the unique identification code associated with new data structure and a password associated with the new data structure, to receive further information for modifying the new data structure.

37. A server terminal for coordinating the receipt, storage, and dissemination of information in an electronic data storage and distribution system, said server terminal comprising:
a. a mechanism constructed and adapted to receive from a member terminal electronic signals representing information to be stored and potentially disseminated;
b. a mechanism constructed and adapted to create a data structure containing said information;
c. a mechanism constructed and adapted to generate and transmit to the member terminal electronic signals representing a unique identification code associated with the data structure;
d. a mechanism constructed and adapted to receive from the member terminal electronic signals representing further information upon receipt from the member terminal of electronic signals representing the unique identification code and a password associated with the data structure, and to incorporate said further information into said data structure; and
e. a mechanism constructed and adapted to transmit electronic signals representing a copy of the data structure upon receipt from a recipient terminal of electronic signals representing the unique identification code associated with the data structure.

38. The server terminal of claim 37 further comprising a mechanism constructed and adapted to transmit electronic signals representing an executable interface program to be run on the recipient terminal for transmitting to the server terminal the unique identification code associated with the data structure and for receiving from the server terminal the electronic signals representing a copy of the data structure.

39. The server terminal of claim 38 further comprising a mechanism constructed and adapted to interface with the interface program to allow for a determination of whether the data structure has been modified since the electronic signals representing the copy of the data structure was received by the recipient terminal.

40. A recipient terminal connectable to a server terminal in an electronic data storage and distribution system, said recipient terminal comprising:
a. a mechanism constructed and adapted to accept as input an identification code uniquely associated with a master data structure stored on the server terminal;
b. a mechanism constructed and adapted to obtain from the server terminal and store as a local data structure electronic signals representing a copy of the master data structure upon providing to the server terminal electronic signals representing the identification code;
c. a mechanism constructed and adapted to display the local data structure on the recipient terminal; and
d. a mechanism constructed and adapted to compare the local data structure to the master data structure so as to determine if the master data structure supplants the local data structure, by virtue of having been modified, and, if so, to obtain from the server terminal electronic signals representing another copy of the master data structure to replace the local data structure.

41. The recipient terminal of claim 40 further comprising:
a. a mechanism constructed and adapted to display an advertisement; and
b. a mechanism constructed and adapted to obtain from the server terminal electronic signals representing a new advertisement to be displayed when the recipient terminal determines if the master data structure supplants the local data structure.

42. A memory for storing data for access by a server terminal in an electronic data storage and distribution system, said memory comprising a plurality of data structures stored in the memory, said data structures each including information to be disseminated as provided by member individuals accessing the server terminal, and each of said data structures further including a password and a unique identification code associated therewith, and said server terminal transmitting electronic signals representing copies of the data structures to recipient terminals upon receipt from the recipient terminals of the unique identification codes associated therewith, and said server terminal transmitting further electronic signals representing further copies of the data structures to the recipient terminals upon a determination that the data structures stored in the memory have been modified since the server terminal transmitted the electronic signals representing copies of the data structures to recipient terminals.

43. An electronic data storage and distribution system comprising:
a. a server terminal having storage means for storing a plurality of data structures each having a password and a unique identification code associated therewith; and
b. an interface program running on a recipient terminal connectable to the server terminal, wherein the interface program comprises:
c. data input means for receiving as input one or more of the identification codes and retrieval means for obtaining from the server terminal copies of the data structures associated with the identification codes received as input by the data input means;
d. data storage means for storing the copies of the data structures on the recipient terminal; and
e. data refreshing means for accessing the server terminal to update any data structure copies stored on the recipient terminal whose corresponding data structures on the server terminal are later modified.

44. The electronic data storage and distribution system of claim 43 wherein the server terminal further comprises data transmission means for transmitting upon request electronic signals representing executable copies of the interface program to terminals connectable to the server terminal.

45. The electronic data storage and distribution system of claim 43 wherein the interface program further comprises:
a. advertisement retrieval means for retrieving an advertisement from the server terminal along with the copies of the data structures associated with the identification codes received as input by the data input means;
b. advertisement display means for displaying the advertisement on the recipient terminal; and
c. advertisement refreshing means for retrieving a modified advertisement for display from the server terminal when the data refreshing means accesses the server terminal.

46. The electronic data storage and distribution system of claim 43 wherein the server terminal further comprises:
a. means for receiving information to be disseminated from a member terminal connectable to the server terminal;
b. means for creating a new data structure to be maintained along with the plurality of data structures on the server terminal, said new data structure incorporating the information received from the member terminal;
c. means for generating and transmitting to the member terminal a unique identification code associated with the new data structure; and
d. means for receiving further information to modify the new data structure upon receipt from the member terminal of the unique identification code associated with the new data structure and a password associated with the new data structure.

47. The electronic data storage and distribution system of claim 43 wherein the server terminal further comprises:
a. means for connecting to a member terminal operated by a member individual desiring to create a new data structure on the server computer to be maintained along with the plurality of data structures on the server terminal;
b. means for receiving information from the member terminal to be included in the new data structure;
c. means for creating the new data structure and generating and transmitting to the member terminal a unique identification code associated with the new data structure, wherein the member individual can disseminate the identification code associated with the new data structure to a recipient individual operating the recipient terminal; and
d. means for receiving further information for modifying the new data structure upon receipt from the member terminal of the unique identification code associated with new data structure and a password associated with the new data structure.

48. An electronic data storage and distribution system having a server terminal and a remote terminal connectable to the server terminal, wherein:
a. the server terminal comprises:
(i) information reception means for receiving information to be disseminated from the remote terminal;
(ii) data structure creation means for creating a master data structure to be maintained on the server terminal, said master data structure incorporating the information received from the remote terminal;
(iii) identification code means for generating and transmitting to the remote terminal a unique identification code associated with the master data structure; and
(iv) data structure modification means for modifying the master data structure upon receipt from the remote terminal of the unique identification code and a password associated with the master data structure; and
b. an interface program runs on the remote terminal, said interface program comprising:
(i) data input means for receiving as input the identification code and data retrieval means for obtaining from the server terminal a copy of the master data structure associated with the identification code received as input by the data input means;
(ii) data storage means for storing the copy of the master data structure on the remote terminal as a local data structure; and
(iii) data refreshing means for accessing the server terminal to update the local data structure if it is determined that the master data structure on the server terminal corresponding to the local data structure has been modified.

49. A server terminal for coordinating the receipt, storage, and dissemination of information in an electronic data storage and distribution system, said server terminal comprising:
a. means for receiving from a member terminal connectable to the server terminal information to be stored and potentially disseminated;
b. means for creating a data structure containing said information;
c. means for generating and transmitting to the member terminal a unique identification code associated with the data structure, wherein said identification code can be disseminated by an individual operating the member terminal to other individuals;
d. means for allowing modification of the data structure by the member terminal upon receipt from the member terminal of the unique identification code and a password associated with the data structure; and
e. means for transmitting a copy of the data structure to a recipient terminal connectable to the server terminal upon receipt from the recipient terminal of the unique identification code associated with the data structure.

50. An electronic data storage and distribution system comprising:
a. a server terminal accessible by a plurality of remote terminals, wherein:
(i) individuals operating the remote terminals can access the server terminal via the remote terminals to set up data structures containing information to be disseminated; and
(ii) each data structure is assigned a unique identification code which can be disseminated by the individuals operating the remote terminals to one another; and
b. an interface program available from the server terminal for running on the remote terminals, wherein:
(i) a list of the identification codes received by any particular individual can be inputted into the interface program running on the remote terminal operated by that individual for obtaining from the server terminal and storing as local data structures copies of the data structures on the server terminal associated with the identification codes inputted into the interface program; and
(ii) the interface program can interface with the server terminal to refresh the local data structures on any particular individual's remote terminal, by determining if any of the data structures on the server terminal corresponding to the local data structures on the particular remote terminal have been modified, and, if so, by obtaining copies of the modified data structures from the server terminal for replacing the local data structures on the particular remote terminal that correspond to the modified data structures.

51. A recipient terminal connectable to a server terminal in an electronic data storage and distribution system, said recipient terminal comprising:
a. means for accepting as input an identification code uniquely corresponding to a data structure stored on the server terminal;
b. means for transmitting to the server terminal the identification code and for obtaining and storing a copy of the data structure from the server terminal;
c. means for displaying the local data structure on the recipient terminal; and
d. means for accessing the server terminal to refresh the copy of the data structure stored on the recipient terminal if the data structure on the server terminal has been modified.

52. Electronically-readable media tangibly embodying a program of instructions executable by a recipient terminal connectable to a server terminal to perform a method of storing and distributing data, said method comprising the steps of:
a. accepting as input an identification code uniquely corresponding to a master data structure stored on the server terminal;
b. transmitting the identification code to the server terminal for purposes of obtaining from the server terminal and storing as a local data structure a copy of the data structure;
c. displaying the local data structure on the recipient terminal; and
d. refreshing the local data structure.

53. The electronically-readable media of claim 52 wherein the method further comprises the steps of:
a. displaying advertisement information contained in an advertisement data structure stored on the recipient terminal; and
b. when the local data structure is refreshed, refreshing the advertisement data structure by determining if the information in the advertisement data structure is different from information in a master advertisement data structure on the server terminal, and, if so, replacing the information in the advertisement data structure on the recipient terminal with the information in the master advertisement data structure on the server terminal.

54. A method of electronically storing and distributing data comprising the steps of:
a. maintaining on a server terminal a master data structure having a password and a unique identification code associated therewith, wherein the master data structure can be modified by providing to the server terminal the password and unique identification code associated with the master data structure;
b. transmitting a copy of the master data structure to a recipient terminal connectable to the server terminal upon the server terminal receiving the unique identification code from the recipient terminal;
c. displaying and storing as a local data structure on the recipient terminal the copy of the master data structure; and
d. accessing the server terminal to determine if the master data structure supplants the local data structure, by virtue of having been modified, and, if so, replacing the supplanted local data structure on the recipient terminal with a copy of the modified master data structure from the server terminal.

55. The method of electronically storing and distributing data of claim 54 further comprising the steps of:
a. receiving information from a member terminal connectable to the server terminal;
b. creating the master data structure on the server terminal, wherein said master data structure includes the information received from the member terminal;
c. generating and transmitting the identification code to the member terminal; and
d. disseminating the identification code to a recipient individual operating the recipient terminal.

56. A method of electronically storing and distributing data comprising the steps of:
a. creating a data structure on a server terminal, wherein:
(i) said data structure has a password and a unique identification code associated therewith; and
(ii) said data structure can be modified by supplying the identification code and password to the server terminal;
b. retrieving a copy of the data structure from the server terminal by providing the identification code to the server terminal; and
c. periodically determining if the data structure has been modified, and, if so, retrieving a copy of the modified data structure to replace the copy of the data structure that was retrieved.

57. A method of electronically storing and distributing data in a system having a server terminal, a recipient terminal operated by a recipient individual and connectable to the server terminal, and a member terminal operated by a member individual and connectable to the server computer, said method comprising the steps of:
a. by the member individual operating the member terminal, creating a data structure on the server terminal, said data structure having a password and a unique identification code associated therewith, and disseminating the identification code to the recipient individual;
b. by the recipient individual operating the recipient terminal, retrieving and executing an executable interface program from the server terminal for use on the recipient terminal, and providing the identification code as input to the interface program;
c. by the interface program, supplying the identification code to the server terminal and obtaining, displaying, and storing a copy of the data structure;
d. by the member individual operating the member terminal, providing the identification code and password to the server terminal to modify the data structure; and
e. by the interface program, accessing the server terminal to determine if the master data structure has been modified, and, if it has, replacing the previously-obtained copy of the master data structure with a copy of the modified master data structure.
